(19) United States
(12) Patent Application Publication
(10) Pub. No.: US 2025/0350063 A1
(43) Pub. Date: Nov. 13, 2025

(54) ELECTRICAL CONNECTOR ASSEMBLY

(71) Applicants: FOXCONN (KUNSHAN) COMPUTER CONNECTOR CO., LTD., Kunshan (CN); FOXCONN INTERCONNECT TECHNOLOGY LIMITED, Grand Cayman (KY)

(72) Inventor: JAMES M. SABO, Marysville, PA (US)

(21) Appl. No.: 19/192,874

(22) Filed: Apr. 29, 2025

Related U.S. Application Data
(60) Provisional application No. 63/643,569, filed on May 7, 2024.

(51) Int. Cl. H01R 13/504; H01R 12/71; H01R 12/75; H01R 13/02; H01R 13/24

(52) U.S. Cl. CPC H01R 13/504; H01R 12/714; H01R 12/716; H01R 12/75; H01R 13/025; H01R 13/2457

(57) ABSTRACT

An electrical connector assembly includes: a plug connector including a plug housing, a front terminal and a rear terminal both secured to the plug housing, and an upper cable connected to the front terminal and a lower cable connected to the rear terminal; and a mating receptacle connector including a receptacle housing and a front contact and a rear contact both secured to the receptacle housing, wherein the plug housing engages the receptacle housing and the front terminal engages the front contact and the rear terminal engages the rear contact.

### CROSS-REFERENCE TO RELATED APPLICATION

This application claims priority to U.S. Provisional Application Ser. No. 63/643,569, filed on May 7, 2024, which is incorporated herein by reference in its entirety.

### BACKGROUND OF THE INVENTION

### Field of the Invention

The present invention relates to an electrical connector assembly comprising a plug connector and a mating receptacle connector, the plug connector including a plug housing, a front terminal and a rear terminal both secured to the plug housing, and an upper cable connected to the front terminal and a lower cable connected to the rear terminal, the receptacle connector including a receptacle housing and a front contact and a rear contact both secured to the receptacle housing.

### Description of Related Arts

U.S. Pat. No. 10,069,223 discloses an electrical cable connector comprising a first front terminal attached to a first upper cable and a second rear terminal attached to a second lower cable. Each of the front and rear terminals has a plurality of contact tails extending downward to be mounted to a printed circuit board.

U.S. Patent Application Publication No. 2022/0336987 discloses an electrical connection assembly comprising a first upper electrical connection terminal connected to a cable, a second lower electrical connection terminal connected to a bus bar, and a mating terminal therebetween with a first mating end matched with the first upper electrical connection terminal and a second mating end second lower electrical connection terminal.

### SUMMARY OF THE INVENTION

An electrical connector assembly comprises: a plug connector including: a plug housing; a front terminal and a rear terminal both secured to the plug housing; and an upper cable connected to the front terminal and a lower cable connected to the rear terminal; and a mating receptacle connector including: a receptacle housing; and a front contact and a rear contact both secured to the receptacle housing, wherein the plug housing engages the receptacle housing and the front terminal engages the front contact and the rear terminal engages the rear contact.

### BRIEF DESCRIPTION OF DRAWINGS

FIG. 1 is a perspective view of an electrical connector assembly in accordance with the present invention mounted to a printed circuit board (PCB);

FIG. 2 is an exploded view of the electrical connector assembly;

FIG. 3 is a view similar to FIG. 2 but from another perspective;

FIG. 4 is a cross-sectional view of the electrical connector assembly taken along line A-A in FIG. 1;

FIG. 5 is another cross-sectional view of the electrical connector assembly taken along line B-B in FIG. 1;

FIG. 6 is an exploded view of a receptacle connector of the electrical connector assembly;

FIG. 7 is a view similar to FIG. 6 but from another perspective;

FIG. 8 is an exploded view of a plug connector of the electrical connector assembly;

FIG. 9 is a view similar to FIG. 8 but from another perspective;

FIG. 10 is a perspective view of upper and lower cables connected to front and rear terminals, respectively, of the plug connector;

FIG. 11 is another exploded view of the plug connector; and

FIG. 12 is a view similar to FIG. 11 but showing that connected cables and terminals are assembled to a lower housing part of the plug connector.

### DETAILED DESCRIPTION OF THE DRAWINGS

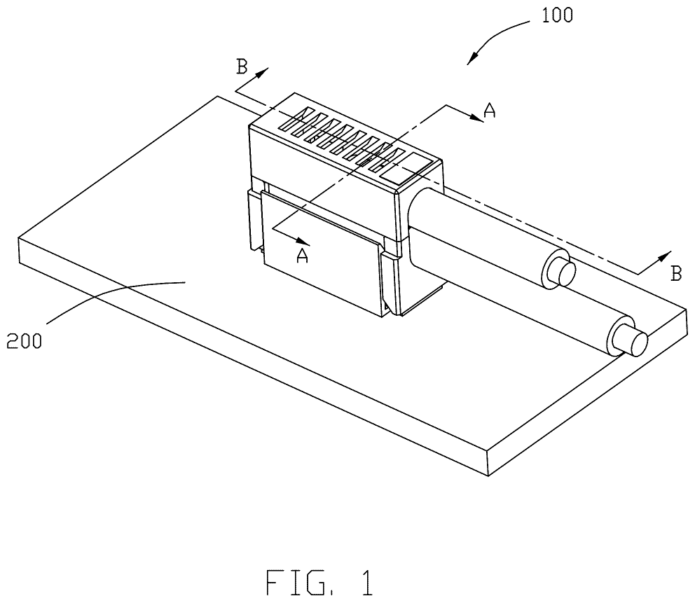

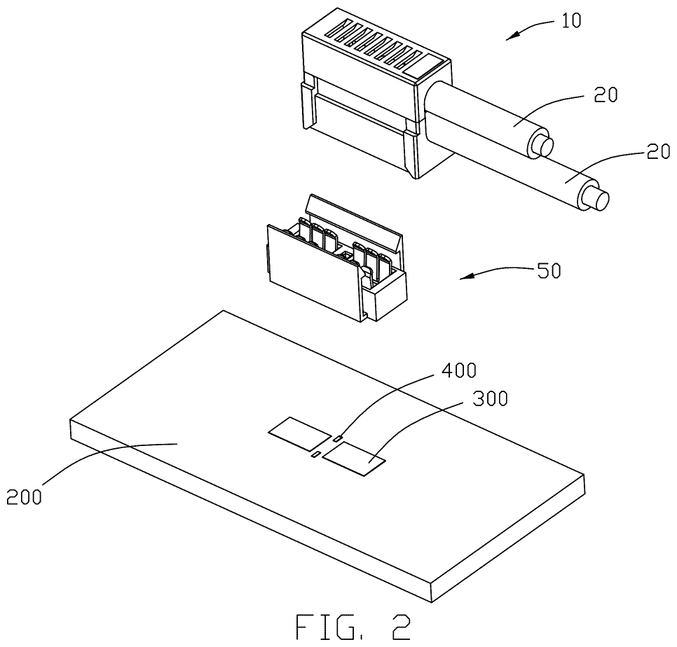

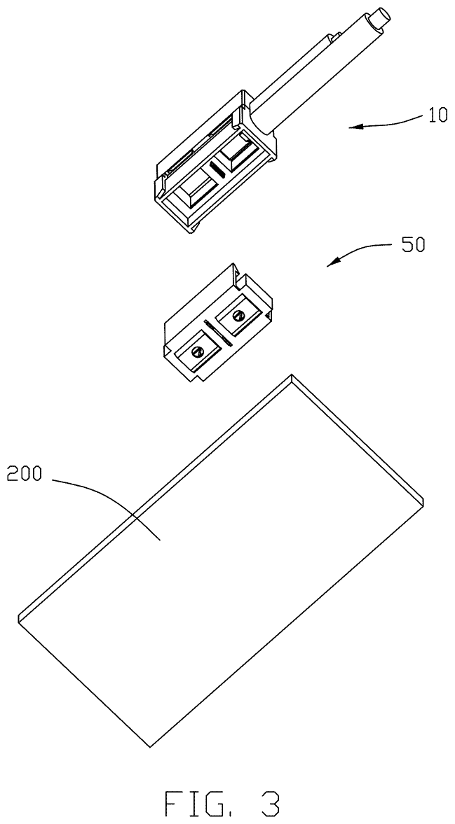

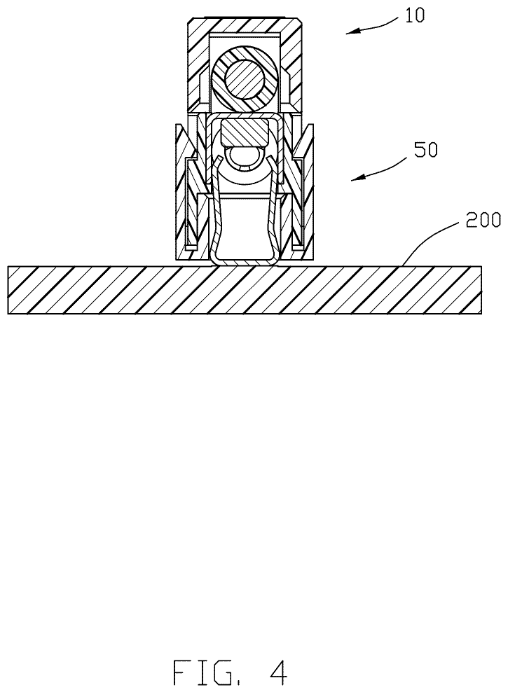

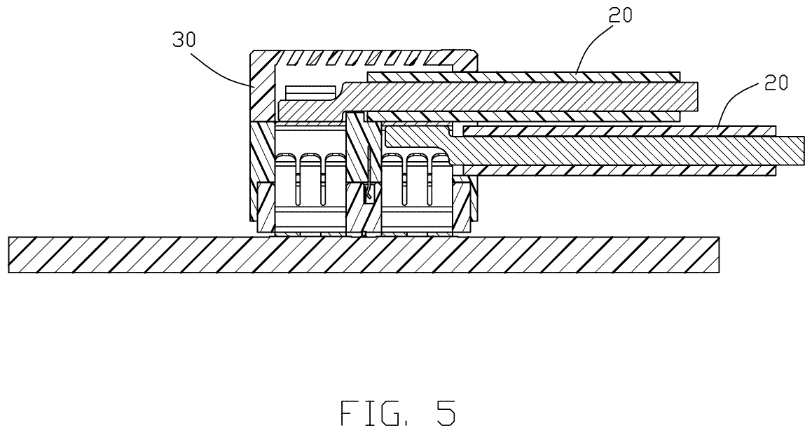

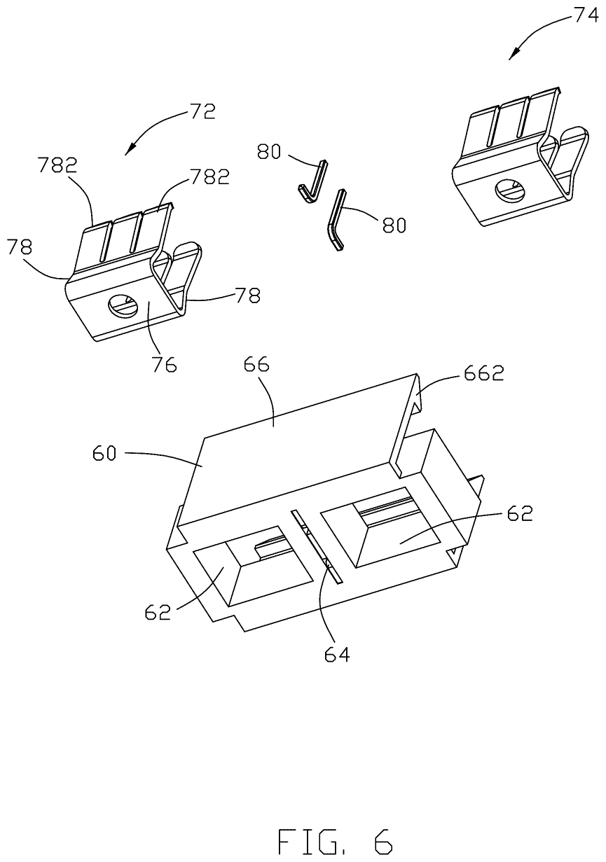

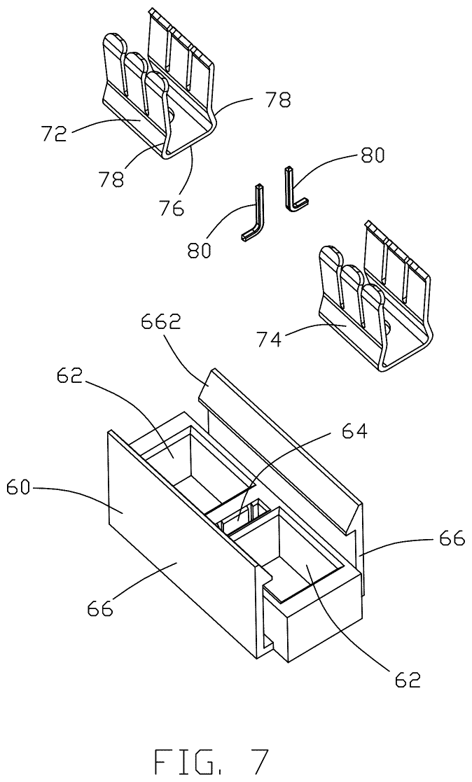

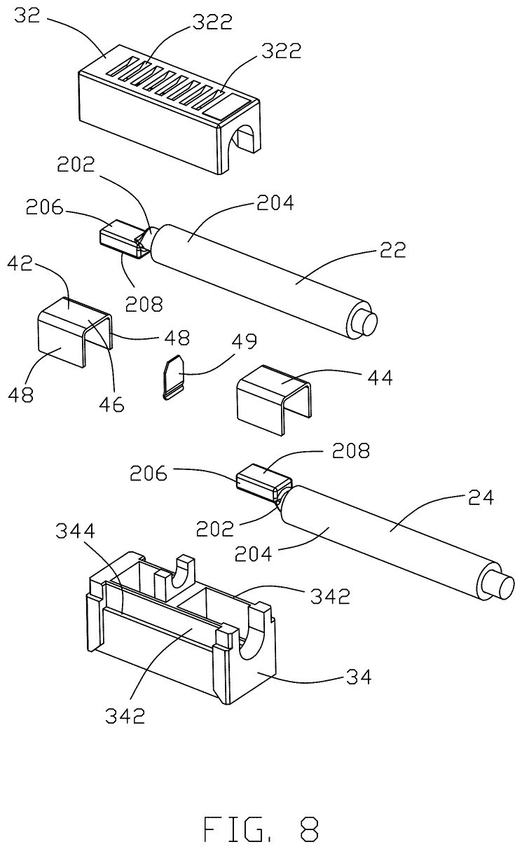

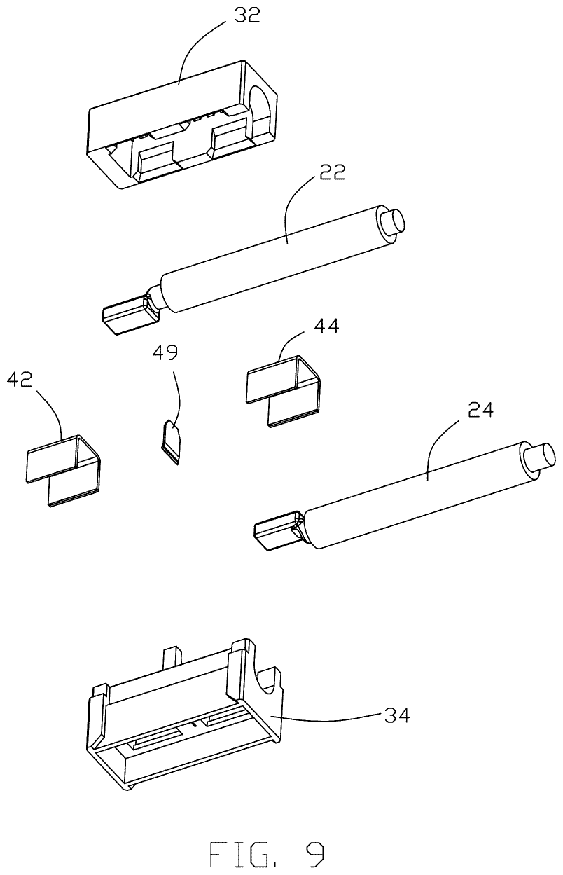

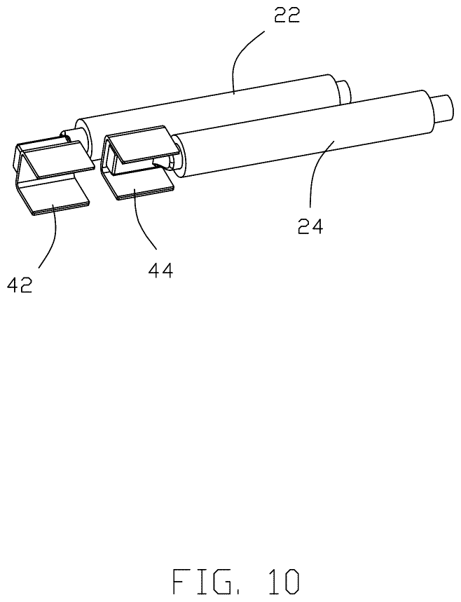

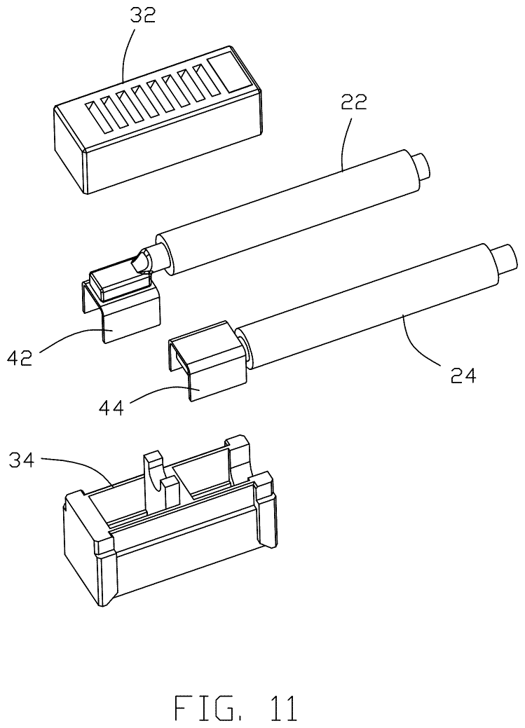

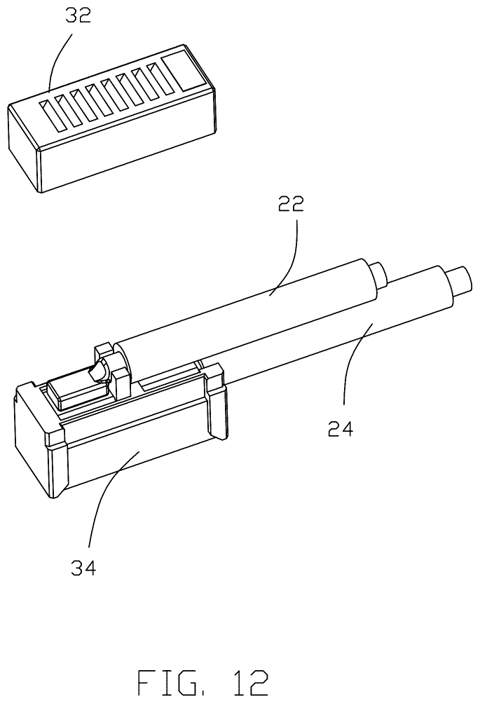

Referring to FIGS. 1-12, an electrical connector assembly 100 comprises a plug connector 10 and a mating receptacle connector 50. The plug connector 10 includes cables 20; the receptacle connector 50 is mounted to a PCB 200. The plug connector 10 includes a plug housing 30 and a front terminal 42 and a rear terminal 44 both secured to the plug housing 30. The front terminal 42 is connected to an upper cable 22 and the rear terminal 44 is connected to a lower cable 24. Each cable 20 may include a conductor 202 and an insulator 204. As is known in this art, the conductor 202 can include wire strands that may be braided, twisted, or otherwise intertwined as desired and can be pre-formed in preparation for being ultrasonically bonded, welded, or soldered to the front terminal 42 or the rear terminal 44. Specifically, as shown in FIGS. 8-12, the conductor 202 of the cable 20 has a pre-formed area exposed from the insulator 204 and shaped so as to define a solidified shape 206 having a keyed surface 208, thus the keyed surface 208 may correspond in shape to a surface of the front terminal 42 or to a surface of the rear terminal 44.

The plug housing 30 may include an upper cap 32 and a lower housing part 34 secured to each other such as by ultrasonically welding while cooperating to clamp the upper cable 22 and the lower cable 24. The upper cap 32 may have a plurality of vent slits 322 for circulation of ambient air. The lower housing part 34 may include a pair of side walls 342 each having a respective step 344. Each of the front terminal 42 and the rear terminal 44 is substantially U-shaped and has a base 46 and a pair of arms 48. Each of the base 46 and the two arms 48 may be substantially planar. The pair of arms 48 are secured to an interior wall surface of the housing 30, preferably interference fit to an interior wall surface of the lower housing part 34. The keyed surface 208 of the conductor 202 of the upper cable 22 is connected to the upper surface of the base 46 of the front terminal 42; the keyed surface 208 of the conductor 202 of the lower cable 24 is connected to the lower surface of the base 46 of the rear terminal 44. The plug connector 10 may further include a communing blade 49 secured to the housing 30, e.g., mounted to the lower housing part 34.

The receptacle connector 50 includes a receptacle housing 60 and a front contact 72 and a rear contact 74 both secured to the receptacle housing 60. Specifically, the front contact 72 and the rear contact 74 are mounted in a pair of holes 62 of the receptacle housing 60. The receptacle housing 60 may include a pair of side walls 66 each having a respective claw 662 latched to a corresponding step 344 of the plug lower housing part 34. Each of the front contact 72 and the rear rear contact 74 is substantially U-shaped and has a base 76 and a pair of arms 78. The base 76 may be substantially planar and may have a venting hole; each of the two arms 78 may be in the form of a flexible spring arm, e.g., with three spring fingers 782. The pair of arms 78 or junction portions of the pair of arms 78 and the base 76 may be secured to an interior wall surface of the housing 60, preferably by way of interference fit. The receptacle connector 50 may further include a pair of separate posts 80 secured to the receptacle housing 60. Correspondingly, the PCB 200 has conductive pads 300 and 400 for electrically connecting to the bases 76 of the front and rear contacts 72 and 74 and the posts 80, respectively. Specifically, the pair of separate posts 80 are exposed to a slot 64 of the receptacle housing 60 between the pair of holes 62 for engaging the communing blade 49 of the plug connector 10 so that when the plug connector 10 and the receptacle connector 50 are mated the communing blade 49 bridges the two posts 80 to complete a circuit through the PCB 200 and send a signal indicating a full mating.

1. An electrical connector assembly comprising:
a plug connector including:
a plug housing;
a front terminal and a rear terminal both secured in the plug housing; and
an upper cable connected to the front terminal and a lower cable connected to the rear terminal; and
a mating receptacle connector including:
a receptacle housing; and
a front contact and a rear contact both secured in the receptacle housing; wherein
the plug housing engages the receptacle housing; and
the front terminal engages the front contact and the rear terminal engages the rear contact.

2. The electrical connector assembly as claimed in claim 1, wherein the plug housing comprises an upper cap and a lower housing part cooperating with each other to clamp the upper cable and the lower cable.

3. The electrical connector assembly as claimed in claim 1, wherein the plug housing comprises an upper cap and a lower housing part secured to each other, and the upper cap has a plurality of vent slits.

4. The electrical connector assembly as claimed in claim 1, wherein each of the front contact and the rear contact of the receptacle connector has a venting hole.

5. The electrical connector assembly as claimed in claim 1, wherein each of the front contact and the rear contact comprises a board-mounting planar portion.

6. The electrical connector assembly as claimed in claim 5, wherein the board-mounting planar portion extends out of the bottom of the receptacle housing and is mounted on a PCB.

7. The electrical connector assembly as claimed in claim 1, wherein the receptacle connector comprises a pair of separate posts secured to the receptacle housing and the plug connector comprises a communing blade secured to the plug housing for bridging the pair of separate posts together.

8. The electrical connector assembly as claimed in claim 1, wherein the plug housing includes a pair of side walls each having a respective step, and the receptacle housing includes a pair of side walls each having a respective claw latched to a corresponding step.

9. A plug connector comprising:
a plug housing;
a front terminal and a rear terminal both secured in the plug housing;
an upper cable connected to the front terminal; and
a lower cable connected to the rear terminal;
wherein the upper cable is supported by the plug housing and passes over a top surface of the rear terminal.

10. The plug connector as claimed in claim 9, wherein each of the front terminal and the rear terminal includes a base at the same height, and the upper cable and the lower cable are connected to the bases.

11. The plug connector as claimed in claim 10, wherein the upper cable is connected to an upper surface of the base of the front terminal and the lower cable is connected to a lower surface of the base of the rear terminal.

12. The plug connector as claimed in claim 9, wherein the plug housing comprises an upper cap and a lower housing part cooperating with each other to clamp the upper cable and the lower cable.

13. The plug connector as claimed in claim 12, wherein the upper cable passes through the upper cap and the lower cable passes through the lower housing part.

14. The plug connector as claimed in claim 9, wherein the plug housing comprises an upper cap and a lower housing part secured to each other, and the upper cap has a plurality of vent slits.

15. A receptacle connector comprising:
a receptacle housing; and
a front contact and a rear contact both secured in the receptacle housing and each substantially U-shaped to have a base and a pair of arms;
wherein the base extends out of the bottom of the receptacle housing for being mounted on a PCB.

16. The receptacle connector as claimed in claim 15, wherein the base is substantially planar and has a venting hole.

17. The receptacle connector as claimed in claim 15, wherein the arm is in the form of a flexible spring arm with three spring fingers.

18. The receptacle connector as claimed in claim 15, wherein the front contact and the rear contact are mounted in a pair of holes of the receptacle housing and the arms extend out of the holes.
